(19) United States
(12) Patent Application Publication
(10) Pub. No.: US 2026/0073195 A1
(43) Pub. Date: Mar. 12, 2026

(54) EFFICIENT MACHINE LEARNING CACHING VIA ATTENTION OUTPUT TOKEN EVICTION

(71) Applicant: QUALCOMM Incorporated, San Diego, CA (US)

(72) Inventors: Farzad FARHADZADEH, San Diego, CA (US); Debasmit DAS, San Diego, CA (US); Fatih Murat PORIKLI, San Diego, CA (US)

(21) Appl. No.: 18/882,595

(22) Filed: Sep. 11, 2024

(51) Int. Cl. G06N 3/0475

(52) U.S. Cl. CPC G06N 3/0475

(57) ABSTRACT

Certain aspects of the present disclosure provide techniques and apparatus for machine learning. In an example method, a first adapted machine learning model comprising a first base model and an adapter trained for the first base model is accessed. A second base model is accessed. One or more linear projections are generated for the second base model based on the first base model, where the one or more linear projections align tensors generated by the second base model with tensors generated by the first base model. A projected base model is generated based on the second base model and the one or more linear projections. A second adapted machine learning model comprising the projected base model and the adapter is generated.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), and/or large multimodal models (LMMs) to process and generate output data. Often, machine learning models (especially LLMs, LVMs, and LMMs) have many parameters (e.g., millions or even billions), resulting in significant model size, as well as substantial computational expense in training the model. Further, once trained, such models are often difficult (or impossible) to fine-tune, as the vast number of parameters makes overfitting a major challenge (e.g., potentially relying on tremendous amounts of fine-tuning data to prevent overfitting).

One recent approach to enable fine-tuning or personalization of such generative models involves training relatively smaller model adapters for larger models. However, adapters trained for such models generally become intrinsically tied to the larger model and may not effectively be reused for other models (even highly similar models). That is, if a large model (e.g., an LLM) is modified even slightly, adapters trained for the original model are generally no longer useful and may not function properly with the modified model.

### BRIEF SUMMARY

Certain aspects of the present disclosure provide a processor-implemented method, comprising: accessing a first adapted machine learning model comprising a first base model and an adapter trained for the first base model; accessing a second base model; generating one or more linear projections for the second base model based on the first base model, wherein the one or more linear projections align tensors generated by the second base model with tensors generated by the first base model; generating a projected base model based on the second base model and the one or more linear projections; and generating a second adapted machine learning model comprising the projected base model and the adapter.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for adapter reuse in machine learning models, according to some aspects of the present disclosure.

FIG. 2 depicts an example architecture for effective adapter reuse in machine learning models, according to some aspects of the present disclosure.

FIG. 3 depicts an architecture for using a pre-trained adapter with a student machine learning model, according to some aspects of the present disclosure.

FIG. 4 is a flow diagram depicting an example method for reusing model adapters in machine learning models, according to some aspects of the present disclosure.

FIG. 5 is a flow diagram depicting an example method for adapting machine learning models, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for reusing model adapters in various machine learning models are provided.

Many model architectures, such as LLMs and LVMs have shown great promise in generating useful output data. In many cases, fine-tuning of such large models is difficult or impossible. Recently, low-rank adaptation (LoRA) adapters have been introduced to address many common challenges of fine-tuning such large models (where the larger model may be referred to as a “base model” that is adapted using an “adapter”). In some aspects, fine-tuning using adapters involves updating the parameters of the adapter(s) while retaining the parameters of the (larger) base model frozen. This can substantially reduce the memory and compute usages of the fine-tuning process. In some aspects, LoRA adapters can be applied to the cross-attention layers of the model, allowing the adapter to better learn to relate output representations (e.g., for images or text) with the prompts that describe the representations. For example, adapters can be trained to modify visual characteristics of the output of the base model, such as the color pallets used, the artistic style, and the like. Advantageously, training such LoRA adapters can be performed substantially faster and with significantly reduced computation as compared to fine-tuning the base model itself.

A variety of base model architectures (e.g., LLMs, LVMs, and LMMs) have been trained for various tasks. For example, in some cases, a first base model may be modified somewhat to create a second base model (e.g., by modifying one or more hyperparameters or parameters). Similarly, a wide variety of adapters have been trained and made available for use for specific base models. However, an adapter trained for one base model is generally not useable with any other base models-even other base models that are highly similar to the base model for which the adapter was trained. For example, even if a first base model (referred to as a “teacher model”) is used to generate or train a smaller second base model (referred to as a “student model”), adapters trained for the teacher model cannot be readily used in conjunction with the student model.

Some conventional approaches have relied on training new adapters for the student model. However, this introduces inherent computational expense to attempt to recapture functionality that the teacher model (with an adapter) already had. Further, in many cases, the data used to train such adapters is kept private or is otherwise not available to train a new adapter. For example, suppose one entity grants access to a base model and an adapter, and a second entity adapts the base model (e.g., generating a student model). Without accessing the training data used by the first entity, the second entity may not successfully train a new adapter to perform similar functionality, and thus should not use the original adapter with the new base model. In some aspects of the present disclosure, techniques are provided to allow for distillation of knowledge from an adapted teacher model (e.g., a first base model with an adapter) to a student model (e.g., a (generally smaller) version of the first base model having a different architecture, a different number of sampling steps, and the like) without relying on access to training data (e.g., the data used to train the adapter). This allows for generation of an adapted student model that can re-use adapters previously trained for the teacher model without introducing the computational expense of further training.

In some aspects, the goal of this knowledge distillation is to cause intermediate outputs of the student model to be, in some way, similar to the intermediate outputs of the teacher model. For example, in some aspects, a projection (e.g., a linear projection) operation can be used to cause the student model's outputs to more closely mirror the teacher model. This allows for adapters trained for the teacher model to be reused by the student model, in some aspects. Advantageously, certain aspects of the present disclosure enable this reuse without relying on any further training or fine-tuning of the student or adapter. Instead, computationally inexpensive operations, such as linear algebra, can be used to enable re-use of the pretrained adapters, substantially increasing the flexibility of the student models.

### Example Workflow for Adapter Reuse in Machine Learning Models

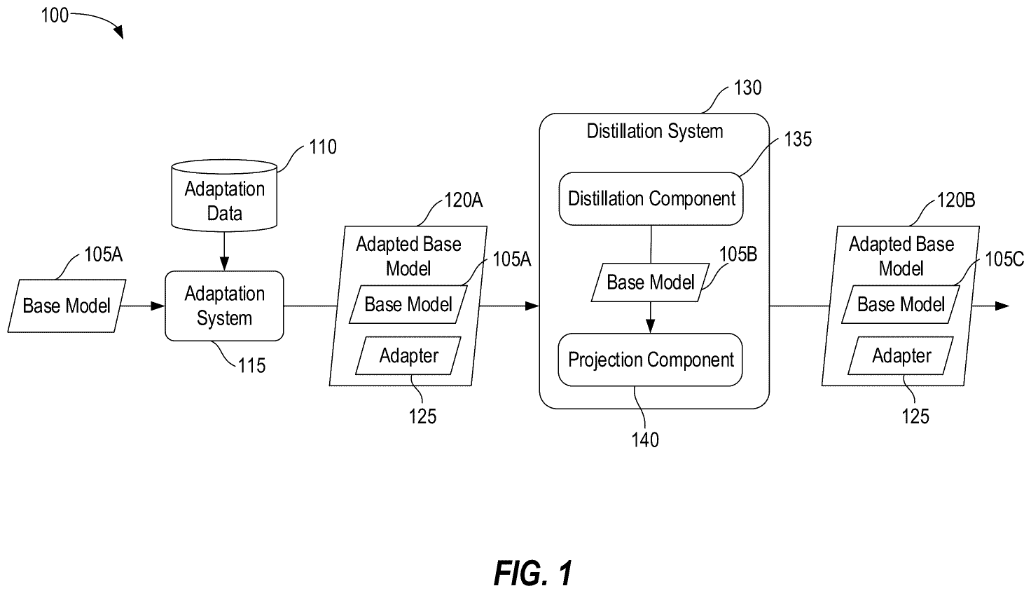

FIG. 1 depicts an example workflow 100 for adapter reuse in machine learning models, according to some aspects of the present disclosure.

In the illustrated example, a first base model 105A is accessed by an adaptation system 115. As used herein, “accessing” data may generally include receiving, retrieving, requesting, obtaining, collecting, generating, training, or otherwise gaining access to the data. For example, the adaptation system 115 may itself train the base model 105A, or the adaptation system 115 may receive the base model 105A from another source (e.g., a dedicated training system). The base model 105A may generally be representative of any machine learning model architecture that can be adapted using adapter models (e.g., LoRA adapters). For example, as discussed above, the base model 105A may correspond to a large model such as an LLM, an LVM, and/or an LMM. As one example, the base model 105A may be an LVM trained to generate output images based on input textual prompts.

The adaptation system 115 is generally representative of any computing system capable of training model adapters for the base model 105A. Though depicted as a single discrete system for conceptual clarity, in some aspects, the operations of the adaptation system 115 may be combined or distributed across any number of systems and may be implemented using hardware, software, or a combination of hardware and software.

In the illustrated workflow 100, the adaptation system 115 also accesses a set of adaptation data 110 (also referred to in some aspects as an “adaptation dataset”). In some aspects, the adaptation data 110 can be used to train or refine an adapter (e.g., a LoRA adapter) for the base model 105A in order to refine or modify outputs (or intermediate tensors) of the base model. For example, as discussed above, the adaptation data 110 may be used to adjust the artistic style of the output images, the color pallet of the output images, the visuals that tend to be included in the images, and the like. In some aspects, though the adaptation data 110 may include similar formatting and structure to the data used to train the base model 105A (e.g., the adaptation data 110 may include images having the desired features and text prompt(s) indicating the desired features), the adaptation data 110 may not have any overlap with the data used to train the base model 105A. That is, the adaptation system 115 may train an adapter without access to the original training data for the base model 105A.

As illustrated, the adaptation system 115 generates an adapted base model 120A. The adapted base model 120A generally includes the base model 105A and an adapter 125. As discussed above, in some aspects, the adaptation system 115 may freeze the parameters of the base model 105A and update one or more parameters of the adapter 125 using the adaptation data 110. This can cause the output of the adapted base model 120A to more accurately reflect the desired content indicated in the adaptation data 110 (e.g., the style).

In the depicted workflow 100, the adapted base model 120A is accessed by a distillation system 130. Although the illustrated example depicts the distillation system 130 accessing the adapted base model 120A directly, in some aspects, the distillation system 130 may access the base model 105A and the adapter 125 separately. For example, the distillation system 130 may access the base model 105A from the same source as the adaptation system 115 (e.g., a training system that trained the base model 105A), while accessing the adapter 125 from the adaptation system 115 itself. Though depicted as a single discrete system for conceptual clarity, in some aspects, the distillation system 130 (or the operations thereof) may be combined or distributed across any number of systems and may be implemented using hardware, software, or a combination of hardware and software.

In the illustrated example, the distillation system 130 includes a distillation component 135 and a projection component 140. Although depicted as discrete components for conceptual clarity, in some aspects, the distillation component 135 and the projection component 140 (or the operations thereof) may be combined or distributed across any number of systems and components.

In the illustrated example, the distillation component 135 may be used to modify the base model 105A to generate a second base model 105B (referred to in some aspects as a “student base model” and/or as “distilled base model”). That is, the student base model 105B may be a modified version of the base model 105A. For example, the student base model 105B may have a different architecture, may use a different number of sampling or diffusion steps, and the like. For example, the distilled base model 105B may be generated by pruning or removing one or more operations, layers, parameters, attention mechanisms, and the like from the base model 105A to generate a somewhat smaller model that can be used with less computational expense. In many cases, despite the similarities between the student base model 105B and the original base model 105A, the adapter 125 (trained for the base model 105A) cannot be readily used with the student base model 105B.

In the illustrated example, the projection component 140 may be used to facilitate or enable this reuse of the adapter 125. Specifically, in some aspects, the projection component 140 may generate or determine linear projection operation(s) that cause tensors generated by the student base model 105B to better align with tensors generated by the base model 105A. For example, the intermediate tensors generated (in the latent space) by each iteration of the student base model 105B may be aligned using the projection(s). In some aspects, the projection component 140 may therefore project the parameters of the student base model 105B to generate a new (projected) base model 105C, as discussed in more detail below.

Although the illustrated example depicts the distillation system 130 as performing both model distillation (to generate the student base model 105B based on the base model 105A) as well as projection (to create the base model 105C based on the student base model 105B), in some aspects, the distillation and projection may be performed by different computing systems. For example, a first system (e.g., a distillation system) may generate a student base model 105B based on the base model 105A, and this student base model 105B may be accessed by a second system (e.g., a projection system) to generate the projected base model 105C.

In the illustrated example, the distillation system 130 generates an adapted base model 120B, which includes the (projected) base model 105C and the adapter 125. That is, the adapter 125, which was trained for the base model 105A and is generally incompatible with the distilled student base model 105B, may be combined with the projected version of the student base model (e.g., the base model 105C). This allows the adapter 125 to be reused without relying on any further training or refinement. That is, the distillation system 130 need not have access to (and does not use) the training data used to train the base model 105A or the adaptation data 110 used to train the adapter 125. Instead, the distillation system 130 can use computationally inexpensive projection (e.g., linear projection) to enable the reuse.

### Example Architecture for Effective Adapter Reuse in Machine Learning Models

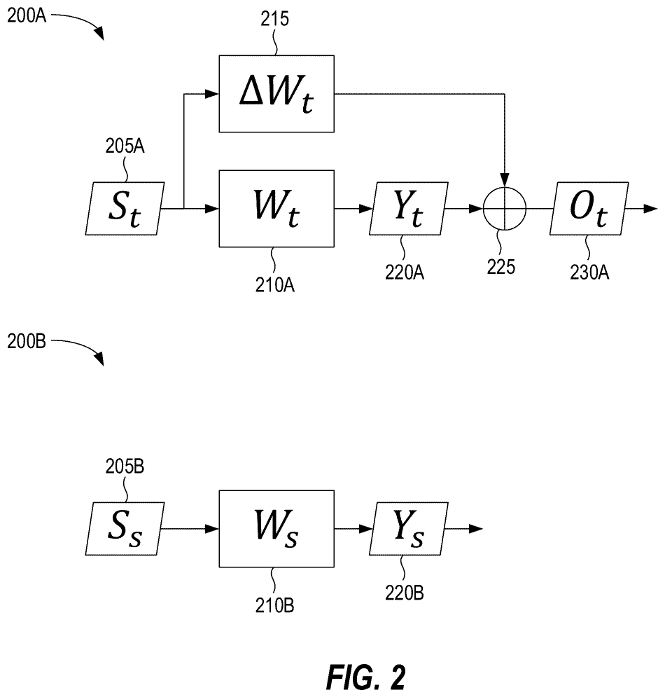

FIG. 2 depicts example architectures 200 for effective adapter reuse in machine learning models, according to some aspects of the present disclosure. Specifically, the illustrated example depicts an architecture 200A (which may correspond to all or a portion of a teacher model, such as the adapted base model 120A of FIG. 1) and an architecture 200B (which may correspond to all or a portion of a student base model, such as the student base model 105B discussed above with reference to FIG. 1).

In the illustrated architecture 200A, a portion 210A of a teacher base machine learning model is depicted (designated as Wₜ in the illustrated example). That is, the portion 210A may correspond to the parameters of a portion of the teacher base model (e.g., the base model 105A of FIG. 1), such as a single layer, an attention operation, and the like. In the illustrated example, the architecture 200A further includes an adapter 215 (designed as ΔWₜ in the illustrated example) that corresponds to the portion 210A of the base model. For example, the adapter 215 may correspond to the parameters of a model adapter (e.g., a LoRA adapter) such as the adapter 125 of FIG. 1. In some aspects, as discussed above, the parameters of the adapter 215 may be trained (e.g., modified, updated, or refined) while the parameters of the portion 210A of the teacher base model are frozen.

In the illustrated example, an input tensor 205A (designated as Sₜ in the illustrated example) for the portion 210A is also provided as input to the adapter 215. Based on the input tensor 205A, the portion 210A generates an output tensor 220A (designated as Yₜ in the illustrated example). As illustrated, the output tensor 220A from the portion 210A of the base model is aggregated with the output of the adapter 215 using an aggregation operation 225. The aggregation operation 225 may generally include a variety of operations, such as elementwise summation, to combine the tensors. In the illustrated example, aggregated tensor 230A (designated as Oₜ), generated by the aggregation operation 225, can then be used as the output of the architecture 200A (e.g., input to a subsequent component or layer, or output from the model). In some aspects, the parameters of the architecture 200A (e.g., the portion 210A and the adapter 215) may be defined as

$${W}_{t}^{*} = {W}_{t} + Δ {W}_{t} .$$

In the illustrated architecture 200B, a portion 210B of a student base machine learning model is depicted (designated as Wₛ in the illustrated example). That is, the portion 210B may correspond to the parameters of a portion of the distilled base model (e.g., the distilled base model 105B of FIG. 1), such as a single layer, an attention operation, and the like. In the illustrated example, the architecture 200B does not include or have a corresponding adapter. In some aspects, as discussed above, the parameters of the portion 210B may be generated based on distilling knowledge from the teacher base model. For example, in some aspects, the portion 210B of the student base model corresponds to the portion 210A of the teacher base model.

In the illustrated example, an input tensor 205B (designated as Sₛ in the illustrated example) for the portion 210B is provided as input to the portion 210B. Based on the input tensor 205B, the portion 210B generates an output tensor 220B (designated as Yₛ in the illustrated example). In some aspects, if no adapter is used, the output tensor 220B can then be used as the output of the architecture 200B (e.g., input to a subsequent component or layer, or output from the model).

As discussed above, in some aspects, a projection system (e.g., the projection component 140 of FIG. 1) seeks to align the intermediate outputs of the student model (e.g., the output tensor 220B from the portion 210B) with the intermediate outputs of the corresponding portions of the teacher model (e.g., the output tensor 220A of the portion 210A). That is, the projection system may seek to make Yₜ and Yₛ close to each other by applying linear projection \hat{P}, allowing the adapter 215 from the teacher model to be adopted by the student model.

Specifically, in some aspects, the projection component may generate a projection \hat{P} that causes the output of each portion of the student base model (e.g., the output tensor 220B) to align with or become more similar to the output of the teacher base model (e.g., the output tensor 220A). In some aspects, the projection component can use Equation 1 below to define the projection, where \hat{P} is a linear projection, Wₛ is the parameters (e.g., a set of weights) of the portion 210B of the student base model, Wₜ is the parameters (e.g., a set of weights) of the portion 210A of the teacher base model, and the superscript T indicates transposition of the associated matrix (e.g.,

$${W}_{s}^{T}$$

is the transposed set of student weights).

$$\hat{P} = {( {W}_{s}^{T} {W}_{s} )}^{- 1} {W}_{s}^{T} {W}_{t} \qquad ( 1 )$$

That is, \hat{P} is a linear projection from the parameters of the student base model (e.g., the portion 210B) to the parameters of the teacher base model (e.g., the portion 210A). Therefore, the projected version of the student base model may be defined as W_{s←t}=W₌ₛ\hat{P}. That is, the weights of a given portion of the student base model (e.g., the parameters Wₛ of the portion 210B) may be multiplied by the projection \hat{P} to yield a (portion of the) projected base model W_{s←t}. Stated differently, one or more linear projections \hat{P} may be applied to one or more portions of the student base model to yield a projected (student) base model.

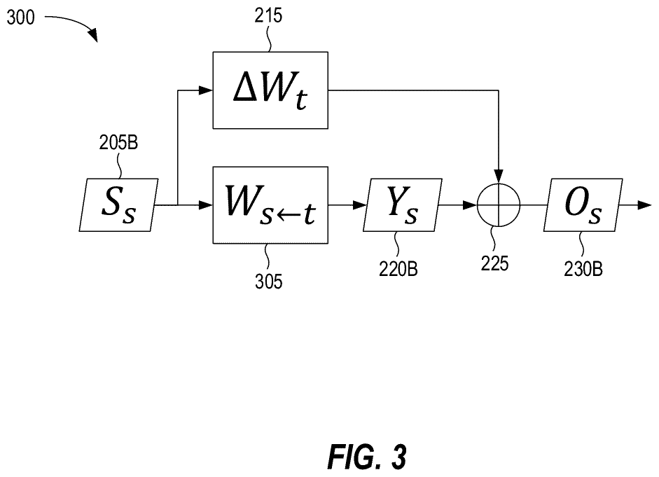

Turning now to FIG. 3, an architecture 300 for using a pre-trained adapter with a student machine learning model, according to some aspects of the present disclosure, is depicted. In the illustrated architecture 300, the portion 210B of the student base model has been replaced with a portion 305 of the projected base model (e.g., a portion of the base model 105C of FIG. 1), designated as W_{s←t}. As illustrated, this projection operation allows the adapter 215, which was trained for the portion 210A of the teacher base model, to be readily applied to the projected base model.

Specifically, as illustrated, an input tensor 205B (designated as Sₛ in the illustrated example) for the (projected) portion 305 is also provided as input to the adapter 215. Based on the input tensor 205B, the portion 305 generates an output tensor 220B (designated as Yₛ in the illustrated example). As illustrated, the output tensor 220B from the portion 305 of the projected base model is aggregated with the output of the adapter 215 using an aggregation operation 225 (e.g., elementwise summation) to generate an aggregated tensor 230B (designated as Oₛ in the illustrated example). This aggregated tensor 230B can then be used as the output of the architecture 300 (e.g., input to a subsequent component or layer, or output from the model). In some aspects, the parameters of the architecture 300 may be defined as

$${W}_{s}^{*} = {W}_{s ← t} + Δ {W}_{t} .$$

That is the architecture 300 may represent a portion of the adapted base model 120B of FIG. 1, where W_{s←t} is the parameters of at least a portion of the projected base model 105C and ΔWₜ is the parameters of at least a portion of the adapter 125.

Advantageously, this projection can be implemented in a training-free manner using computationally inexpensive linear projections, allowing pre-trained adapters for a given base model to be reused by any number and variety of modified versions of the base model.

### Example Method for Reusing Model Adapters in Machine Learning Models

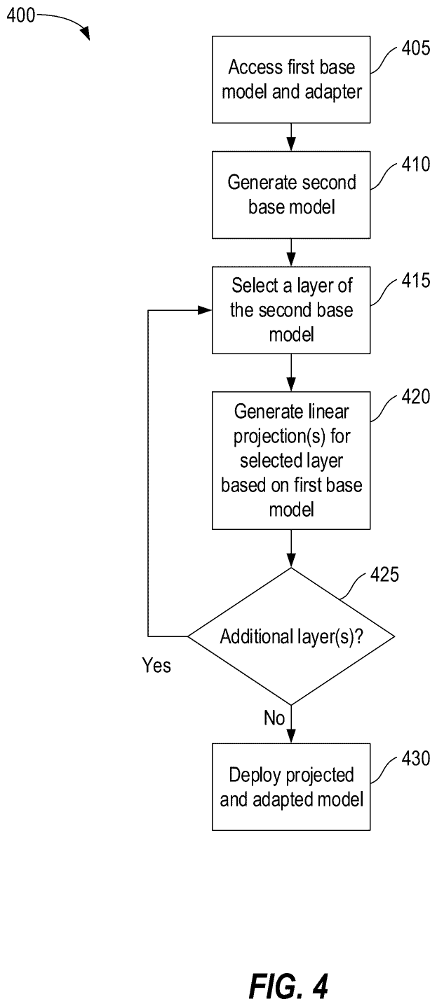

FIG. 4 is a flow diagram depicting an example method 400 for reusing model adapters in machine learning models, according to some aspects of the present disclosure. In some aspects, the method 400 is performed by a computing system such as the distillation system 130 of FIG. 1.

At block 405, the computing system accesses a first base model (e.g., the base model 105A of FIG. 1) and an adapter (e.g., adapter 125 of FIG. 1) for the first base model. In some aspects, as discussed above, the base model may generally correspond to a base model of a generative model such as an LLM, an LVM, an LMM, and the like. Further, as discussed above, the adapter may generally correspond to a relatively small set of parameters trained (based on a relatively small set of training data, as compared to the data used to train the base model) to modify the output of the base model (e.g., to modify the style of the outputs). In some aspects, the adapter corresponds to or comprises one or more LoRA adapters.

At block 410, the computing system generates a second base model (e.g., the student base model 105B of FIG. 1) based on the first base model. For example, in some aspects, the second base model may correspond to a modified version of the first base model. The second base model may be generated by performing various actions, such as pruning one or more components of the first base model, reducing or modifying the number of sampling steps used to generate output, and the like. In some aspects, as discussed above, the second base model may be a distilled version of the first base model (e.g., intended to perform the same task or a similar task with reduced computational expense). Although the illustrated example depicts generating the second base model, in some aspects, the computing system may receive the second base model from another system, as discussed above.

At block 415, the computing system selects a layer (or other portion) of the second base model for which an adapter will be used. That is, the computing system may determine which layer(s) (or other portions) of the first base model have a corresponding portion of the adapter (e.g., where the portion 210A of FIG. 2 has the corresponding adapter 215), and which layer(s) or portion(s) of the second base model correspond to these adapted portions of the first base model (e.g., where the portion 210B of FIG. 2 corresponds to the portion 210A because the portion 210B was generated based on distilling the portion 210A of the teacher model).

Generally, the computing system may use a variety of techniques to select the layer of the second base model at block 415, as the computing system will process each relevant (adapted) portion during the method 400.

At block 420, the computing system generates one or more linear projections for the selected layer (or other portion) of the second base model based on the corresponding layer (or other portion) of the first base model. For example, as discussed above, the computing system may generate the projection P using Equation 1 above. By multiplying this projection by the parameters of the selected portion of the second base model (e.g., Wₛ), the computing system can efficiently project the parameters of the second base model to align or be more similar to the parameters of the first base model (e.g., to generate W_{s←t}). As discussed above, these projections can therefore be used to create a projected base model (e.g., by projecting the parameters of each layer based on the corresponding projection(s)).

At block 425, the computing system determines whether there is at least one additional adapted layer (or other portion) remaining in the second base model. If so, the method 400 returns to block 415. If not, the method 400 continues to block 430. Although the illustrated example depicts an iterative process (e.g., selecting and processing each layer of the second base model in sequence) for conceptual clarity, in some aspects, the computing system may process some or all of the layers of the second base model entirely or partially in parallel.

At block 430, the computing system deploys the projected second base model, along with the adapter of the first base model, as a projected and adapted base model (e.g., the adapted base model 120B of FIG. 1). That is, the computing system may deploy the combination of the projected second base model and the adapter from the teacher. As used herein, “deploying” the model may generally include performing any operations used to prepare or provide the model for runtime use, including generating and/or transmitting a model binary file, transferring the parameters to local memory for use, and the like.

### Example Method for Adapting Machine Learning Models

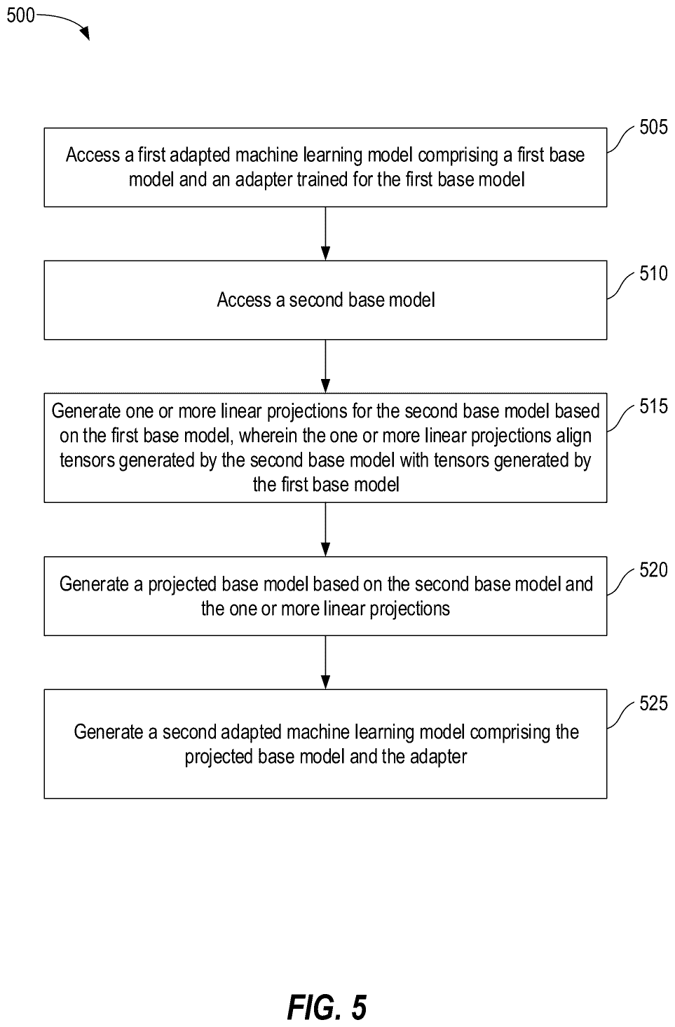

FIG. 5 is a flow diagram depicting an example method for adapting machine learning models, according to some aspects of the present disclosure.

At block 505, a first adapted machine learning model (e.g., the adapted base model 120A of FIG. 1) comprising a first base model (e.g., the base model 105A of FIG. 1) and an adapter trained for the first base model (e.g., the adapter 125 of FIG. 1) is accessed.

At block 510, a second base model (e.g., the base model 105B of FIG. 1) is accessed.

At block 515, one or more linear projections for the second base model are generated based on the first base model, wherein the one or more linear projections align tensors generated by the second base model with tensors generated by the first base model.

At block 520, a projected base model (e.g., the base model 105C of FIG. 1) is generated based on the second base model and the one or more linear projections.

At block 525, a second adapted machine learning model (e.g., the adapted base model 120B of FIG. 1) comprising the projected base model and the adapter is generated.

In some aspects, the first base model comprises a generative model and wherein the adapter comprises a low-rank adaptation (LoRA) adapter.

In some aspects, generating the one or more linear projections comprises generating, for each respective layer of a plurality of layers in the second base model, a respective linear projection based on a respective corresponding layer in the first base model.

In some aspects, at least one of the one or more linear projections is defined as

$$\hat{P} = {( {W}_{s}^{T} {W}_{s} )}^{- 1} {W}_{s}^{T} {W}_{t} ,$$

where \hat{P} is the at least one linear projection, Wₛ is a set of weights of the second base model, and Wₜ is a set of weights of the first base model.

In some aspects, the projected base model is defined as W_{s←t}=Wₛ\hat{P}, where W_{s←t} is the projected base model.

In some aspects, the second adapted machine learning model is defined as Wₛ*=W_{s←t}+ΔWₜ, where: Wₛ* is the second adapted machine learning model, and ΔWₜ is the adapter.

In some aspects, the method 500 further includes deploying the second adapted machine learning model.

In some aspects, the method 500 further includes generating a model output based on processing a model input using the second adapted machine learning model.

In some aspects, generating the one or more linear projections, generating the projected base model, and generating the second adapted machine learning model are performed without processing data used to train the adapter (e.g., the adaptation data 110 of FIG. 1).

In some aspects, the second base model corresponds to a modified version of the first base model.

### Example Processing System for Machine Learning

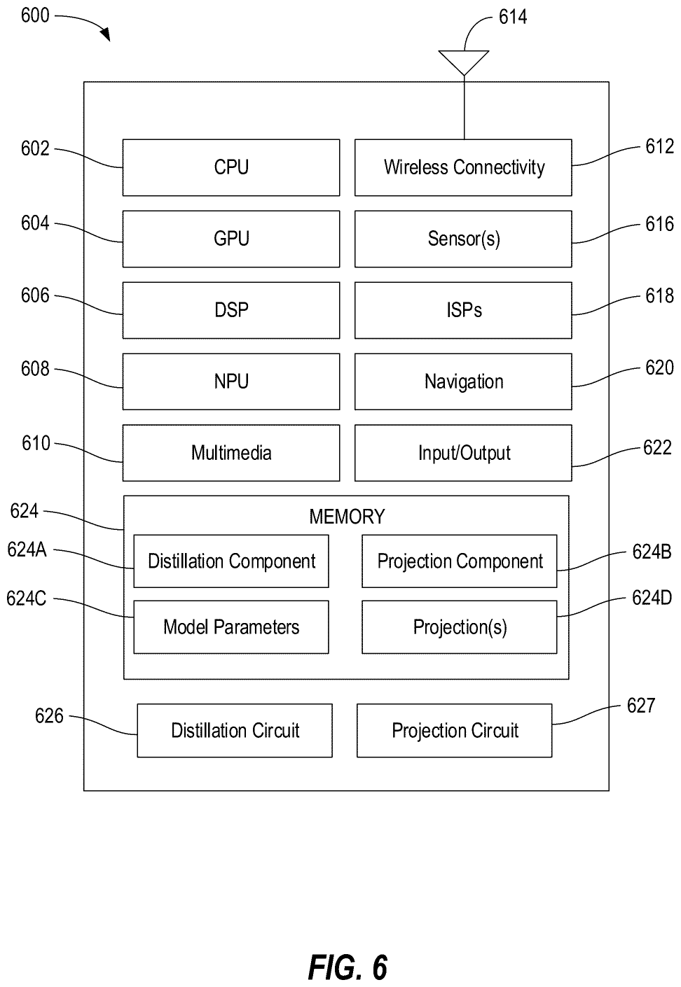

FIG. 6 depicts an example processing system 600 configured to perform various aspects of the present disclosure, including, for example, the techniques and methods described with respect to FIGS. 1-5. In some aspects, the processing system 600 may correspond to a computing system. For example, the processing system 600 may correspond to the distillation system 130 of FIG. 1 and/or the computing systems discussed above with reference to FIGS. 2-5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a distillation component 624A and a projection component 624B. Although not depicted in the illustrated example, the memory 624 may also include other components, such as a training component used to train or update machine learning model(s) or adapters, an inferencing component used to manage generation of model output during runtime, and the like. Though depicted as discrete components for conceptual clarity in FIG. 6, the illustrated components (and others not depicted) may be collectively or individually implemented in various aspects.

Further, in the illustrated example, the memory 624 also includes a set of model parameters 624C (e.g., parameters of one or more machine learning models, such as base models and/or adapters) and a set of projections 624D. In some aspects, the model parameters 624C may correspond to or include the parameters of one or more base models (e.g., the first base model 105A of FIG. 1), one or more distilled base models (e.g., the distilled or student version of the base model 105A), and/or one or more projected base models (e.g., the parameters of the base model 105B of FIG. 1). In some aspects, the model parameters 624C may further include the parameters of one or more adapter models (e.g., the adapter 125 of FIG. 1 and/or the adapter 215 of FIGS. 2-3). In some aspects, the projections 624D may indicate linear projections from the parameters of a distilled base model to the parameters of the original base model based on which the distilled model was generated (e.g., the projections \hat{P}).

Although not depicted in the illustrated example, in some aspects, the memory 624 may include other data such as a training data for the machine learning model(s).

The processing system 600 further comprises a distillation circuit 626 and a projection circuit 627. The depicted circuits, and others not depicted (such as an inferencing circuit), may be configured to perform various aspects of the techniques described herein.

The distillation component 624A and/or the distillation circuit 626 (which may correspond to the distillation component 135 of FIG. 1) may be used to generate modified (e.g., distilled) versions of base machine learning models, as discussed above. For example, the distillation component 624A and/or the distillation circuit 626 may be used to generate modified architectures that use reduced sampling steps, reduced layers, and the like.

The projection component 624B and/or the projection circuit 627 (which may correspond to the projection component 140) may be used to generate and/or apply projections to distilled (e.g., student) base models, as discussed above. For example, the projection component 624B and/or the projection circuit 627 may use Equation 1 above to generate the projection(s), and may then project the parameters of the distilled base model to allow adapters trained for the original teacher model to be re-used with the projected base model, as discussed above.

Though depicted as separate components and circuits for clarity in FIG. 6, the distillation circuit 626 and the projection circuit 627 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Implementation examples are described in the following numbered clauses:

Clause 1: A method, comprising: accessing a first adapted machine learning model comprising a first base model and an adapter trained for the first base model; accessing a second base model; generating one or more linear projections for the second base model based on the first base model, wherein the one or more linear projections align tensors generated by the second base model with tensors generated by the first base model; generating a projected base model based on the second base model and the one or more linear projections; and generating a second adapted machine learning model comprising the projected base model and the adapter.

Clause 2: A method according to Clause 1, wherein the first base model comprises a generative model and wherein the adapter comprises a low-rank adaptation (LoRA) adapter.

Clause 3: A method according to any of Clauses 1-2, wherein generating the one or more linear projections comprises generating, for each respective layer of a plurality of layers in the second base model, a respective linear projection based on a respective corresponding layer in the first base model.

Clause 4: A method according to any of Clauses 1-3, wherein at least one of the one or more linear projections is defined as

$$\hat{P} = {( {W}_{s}^{T} {W}_{s} )}^{- 1} {W}_{s}^{T} {W}_{t} ,$$

where: \hat{P} is the at least one linear projection, Wₛ is a set of weights of the second base model, and Wₜ is a set of weights of the first base model.

Clause 5: A method according to Clause 4, wherein the projected base model is defined as W_{s←t}=Wₛ\hat{P}, where W_{s←t} is the projected base model.

Clause 6: A method according to Clause 5, wherein the second adapted machine learning model is defined as

$${W}_{s}^{*} = {W}_{s ← t} + Δ {W}_{t} ,$$

where

$${W}_{s}^{*}$$

is the second adapted machine learning model, and ΔWₜ is the adapter.

Clause 7: A method according to any of Clauses 1-6, further comprising deploying the second adapted machine learning model.

Clause 8: A method according to any of Clauses 1-7, further comprising generating a model output based on processing a model input using the second adapted machine learning model.

Clause 9: A method according to any of Clauses 1-8, wherein generating the one or more linear projections, generating the projected base model, and generating the second adapted machine learning model are performed without processing data used to train the adapter.

Clause 10: A method according to any of Clauses 1-9, wherein the second base model corresponds to a modified version of the first base model.

Clause 11: A processing system comprising: a memory comprising processor-executable instructions; and one or more processors coupled to the one or more memories and configured to execute the processor-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a first adapted machine learning model comprising a first base model and an adapter trained for the first base model;
access a second base model;
generate one or more linear projections for the second base model based on the first base model, wherein the one or more linear projections align tensors generated by the second base model with tensors generated by the first base model;
generate a projected base model based on the second base model and the one or more linear projections; and
generate a second adapted machine learning model comprising the projected base model and the adapter.

2. The processing system of claim 1, wherein the first base model comprises a generative model and wherein the adapter comprises a low-rank adaptation (LoRA) adapter.

3. The processing system of claim 1, wherein, to generate the one or more linear projections, the one or more processors are configured to execute the processor-executable instructions and cause the processing system to generate, for each respective layer of a plurality of layers in the second base model, a respective linear projection based on a respective corresponding layer in the first base model.

4. The processing system of claim 1, wherein at least one of the one or more linear projections is defined as
$$\hat{P} = {( {W}_{s}^{T} {W}_{s} )}^{- 1} {W}_{s}^{T} {W}_{t} ,$$
where:
\hat{P} is the at least one linear projection,
Wₛ is a set of weights of the second base model, and
Wₜ is a set of weights of the first base model.

5. The processing system of claim 4, wherein the projected base model is defined as W_{s←t}=Wₛ\hat{P}, where W_{s←t} is the projected base model.

6. The processing system of claim 5, wherein the second adapted machine learning model is defined as
$${W}_{s}^{*} = {W}_{s ← t} + Δ {W}_{t} ,$$
where:
$${W}_{s}^{*}$$
is the second adapted machine learning model, and
ΔWₜ is the adapter.

7. The processing system of claim 1, wherein the one or more processors are configured to execute the processor-executable instructions and further cause the processing system to deploy the second adapted machine learning model.

8. The processing system of claim 1, wherein the one or more processors are configured to execute the processor-executable instructions and further cause the processing system to generate a model output based on processing a model input using the second adapted machine learning model.

9. The processing system of claim 1, wherein generation of the one or more linear projections, the projected base model, and the second adapted machine learning model are performed without processing data used to train the adapter.

10. The processing system of claim 1, wherein the second base model corresponds to a modified version of the first base model.

11. A processor-implemented method for machine learning, comprising:
accessing a first adapted machine learning model comprising a first base model and an adapter trained for the first base model;
accessing a second base model;
generating one or more linear projections for the second base model based on the first base model, wherein the one or more linear projections align tensors generated by the second base model with tensors generated by the first base model;
generating a projected base model based on the second base model and the one or more linear projections; and
generating a second adapted machine learning model comprising the projected base model and the adapter.

12. The processor-implemented method of claim 11, wherein the first base model comprises a generative model and wherein the adapter comprises a low-rank adaptation (LoRA) adapter.

13. The processor-implemented method of claim 11, wherein generating the one or more linear projections comprises generating, for each respective layer of a plurality of layers in the second base model, a respective linear projection based on a respective corresponding layer in the first base model.

14. The processor-implemented method of claim 11, wherein at least one of the one or more linear projections is defined as
$$\hat{P} = {( {W}_{s}^{T} {W}_{s} )}^{- t} {W}_{s}^{T} {W}_{t} ,$$
where:
\hat{P} is the at least one linear projection,
Wₛ is a set of weights of the second base model, and
Wₜ is a set of weights of the first base model.

15. The processor-implemented method of claim 14, wherein the projected base model is defined as W_{s←t}=Wₛ\hat{P}, where W_{s←t} is the projected base model.

16. The processor-implemented method of claim 15, wherein the second adapted machine learning model is defined as
$${W}_{s}^{*} = {W}_{s ← t} + Δ {W}_{t} ,$$
where:
$${W}_{s}^{*}$$
is the second adapted machine learning model, and
ΔWₜ is the adapter.

17. The processor-implemented method of claim 11, further comprising deploying the second adapted machine learning model.

18. The processor-implemented method of claim 11, further comprising generating a model output based on processing a model input using the second adapted machine learning model.

19. The processor-implemented method of claim 11, wherein generating the one or more linear projections, generating the projected base model, and generating the second adapted machine learning model are performed without processing data used to train the adapter.

20. A processing system, comprising:
means for accessing a first adapted machine learning model comprising a first base model and an adapter trained for the first base model;
means for accessing a second base model;
means for generating one or more linear projections for the second base model based on the first base model, wherein the one or more linear projections align tensors generated by the second base model with tensors generated by the first base model;
means for generating a projected base model based on the second base model and the one or more linear projections; and
means for generating a second adapted machine learning model comprising the projected base model and the adapter.
